(19) United States
(12) Patent Application Publication
(10) Pub. No.: US 2023/0241614 A1
(43) Pub. Date: Aug. 3, 2023

(54) DROPLET MICROFLUIDIC CHIP AND METHOD FOR PRODUCING MICRODROPLETS

(71) Applicant: SHENZHEN YHLO BIOTECH CO., LTD., Shenzhen (CN)

(72) Inventors: Shunji LI, Shenzhen (CN); Xiaoyu CHENG, Shenzhen (CN); Bifeng LIU, Shenzhen (CN); Chungen QIAN, Shenzhen (CN); Kunhui HU, Shenzhen (CN)

(21) Appl. No.: 18/015,614

(22) PCT Filed: Aug. 3, 2021
(86) PCT No.: PCT/CN2021/110216

§ 371 Date: Jan. 11, 2023

(30) Foreign Application Priority Data
Sep. 7, 2020 (CN) 202010928831.0

(51) Int. Cl. B01L 3/00

(52) U.S. Cl. CPC B01L 3/502784; B01L 2300/0803; B01L 2400/0409; B01L 2200/0684; B01L 2300/0681

(57) ABSTRACT

A droplet microfluidic chip and a method for producing microdroplets are disclosed. The droplet microfluidic chip includes at least one droplet-producing unit. The droplet-producing unit includes a dispersion phase chamber, a quantitation chamber, a capillary nozzle, and a continuous phase chamber. The droplet microfluidic chip has a rotation center. The dispersion phase chamber is provided with a loading hole configured to introduce a dispersion phase liquid. The quantitation chamber is in communication with the dispersion phase chamber and further away from the rotation center than the dispersion phase chamber. The capillary nozzle is further away from the rotation center than the quantitation chamber. One end of the capillary nozzle is in communication with the quantitation chamber, and the capillary nozzle is extended from the joining end in a direction away from the rotation center. The continuous phase chamber is in communication with the other end of the capillary nozzle away from the quantitation chamber, and the continuous phase chamber is further away from the rotation center than the capillary nozzle. The continuous phase chamber accommodates a continuous phase liquid.

### CROSS-REFERENCE TO RELATED APPLICATIONS

This application claims priority to Chinese Patent Application No. 2020109288310, filed on Sep. 7, 2020 with Chinese patent office, entitled “DROPLET MICROFLUIDIC CHIP AND METHOD FOR PRODUCING MICRODROPLETS”, the content of which is hereby incorporated by reference in its entirety.

### TECHNICAL FIELD

The present disclosure relates to the technical field of microfluidics, and in particular to droplet microfluidic chips and methods for producing microdroplets.

### BACKGROUND

Microfluidics refers to a technology that manipulates fluids in micron-scale space, which can miniaturize the laboratory basic functions such as chemical and biological functions onto a chip of a few square centimeters, and is therefore also known as a lab-on-a-chip. Droplet-based microfluidics, which is an important branch of microfluidic chip research, has been developed in recent years based on traditional continuous flow microfluidic systems. Droplet-based microfluidic technology has broad applications in biomedicines. For example, in a reaction, microdroplets can be precisely manipulated so that the consumption of reaction reagents can be reduced and the reagent utilization efficiency can be improved. Thousands or even millions of microdroplets at picoliter scale with good monodispersity are produced and used as separate reaction units in combination with technological means, such as fluorescence imaging analysis, spectroscopy, electrochemistry, capillary electrophoresis, mass spectrometry, nuclear magnetic resonance spectroscopy, and chemiluminescence assay, to realize qualitative or quantitative applications in the fields such as molecular diagnostics, immunobiochemistry, cell culture, macromolecule synthesis, single cell analysis, drug transport, etc.

However, the existing chips for producing microdroplets are not suitable for most of researches and mass productions due to the poor stability and reproducibility, complex droplet-producing process, and high requirements on equipment.

### SUMMARY

A droplet microfluidic chip and a method for producing microdroplets are provided according to various embodiments.

A droplet microfluidic chip includes at least one droplet-producing unit. The droplet microfluidic chip has a rotation center. The droplet-producing unit includes:
a dispersion phase chamber being proximal to the rotation center and provided with a loading hole configured to introduce a dispersion phase liquid;
a quantitation chamber being in communication with the dispersion phase chamber and further away from the rotation center than the dispersion phase chamber;
a capillary nozzle, one end of the capillary nozzle being in communication with the quantitation chamber and extended in a direction away from the rotation center, and the capillary nozzle being further away from the rotation center than the quantitation chamber; and
a continuous phase chamber configured to pre-store a continuous phase liquid, the continuous phase chamber being in communication with another end of the capillary nozzle away from the quantitation chamber, and the continuous phase chamber being further away from the rotation center than the capillary nozzle.

A method for producing microdroplets includes: providing the above-described droplet microfluidic chip; loading a dispersion phase liquid into the dispersion phase chamber through the loading hole, and centrifuging the droplet microfluidic chip with a centrifugal force of 5 g to 100 g to force the dispersion phase liquid into the quantitation chamber from the dispersion phase chamber; forcing the dispersion phase liquid into the continuous phase chamber from the quantitation chamber through the capillary nozzle by increasing the centrifugal force to 500 g to 18000 g, thereby producing the microdroplets.

The above description is only a summary of the technical solutions of the present disclosure. In order to understand the technical means of the present disclosure more clearly and to implement the present disclosure according to the content of the specification, hereafter the preferred embodiments of the present disclosure will be detailed described as follows in conjunction with the accompanying drawings.

### BRIEF DESCRIPTION OF THE DRAWINGS

In order to illustrate the solutions in the embodiments of the present disclosure or in the conventional technology more clearly, the drawings used in the description of the embodiments or the conventional technology will be described briefly as follows. Apparently, the following described drawings are merely some embodiments of the present disclosure, and other drawings can be derived from these drawings by one of ordinary skill in the art without any creative effort.

FIG. 1 is a front view of a droplet microfluidic chip according to an embodiment.

FIG. 2 is a front view of a droplet-producing unit as shown in FIG. 1.

FIG. 3 is an exploded perspective view of the droplet microfluidic chip as shown in FIG. 1.

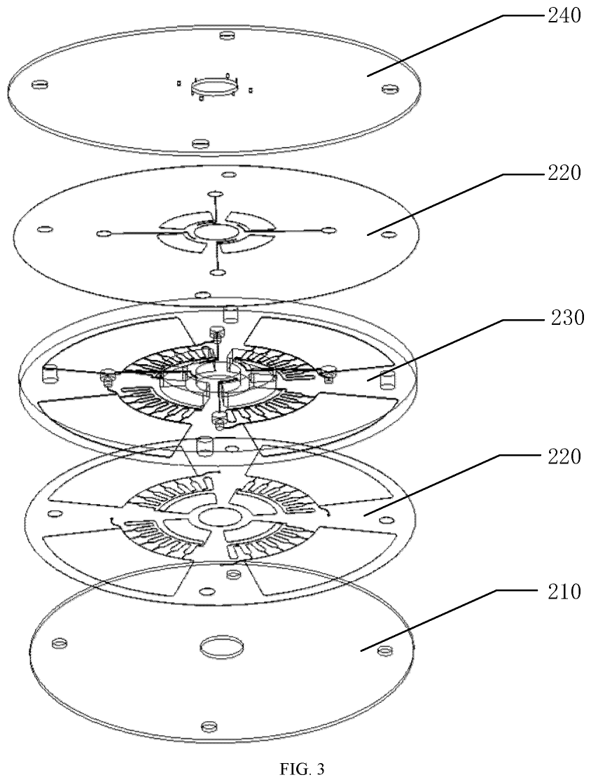

FIG. 4 is a flowchart of a method for producing microdroplets according to an embodiment.

### DETAILED DESCRIPTION

In order to facilitate understanding of the present disclosure, the present disclosure will be comprehensively described and the preferred embodiments of the present disclosure will be provided. However, the present disclosure can be implemented in many different forms and therefore is not limited to the embodiments described herein. In contrast, the purpose of providing these embodiments is to thoroughly and comprehensively understand the present disclosure.

Unless otherwise defined, all the technical and scientific terms used herein have the same meaning as commonly understood by the person skilled in the art to which the present disclosure belongs. Herein, the terms used in the description of the present disclosure are merely for the purpose of describing specific examples without limiting the present disclosure. The term “and/or” used herein includes any and all combinations of one or more of the associated listed items.

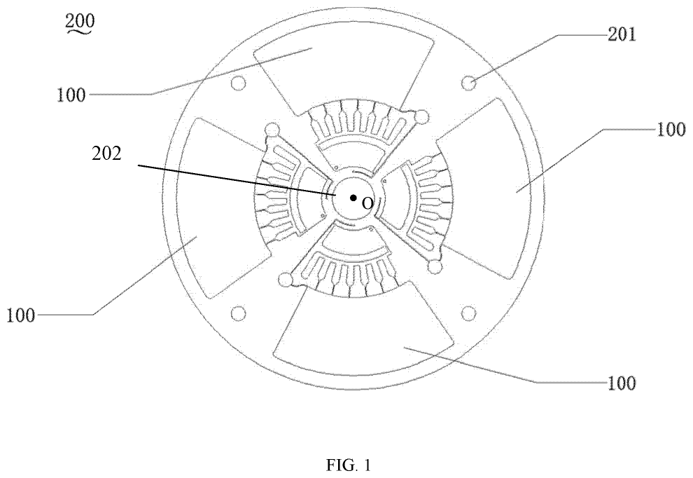

As shown in FIG. 1, a droplet microfluidic chip 200 according to an embodiment of the present disclosure includes a plurality of droplet-producing units 100. The droplet microfluidic chip 200 is substantially circular in shape. A mounting hole 202 is provided in a central portion of the droplet microfluidic chip 200 and used for mounting the droplet microfluidic chip 200 onto a centrifuge. The droplet microfluidic chip 200 has a rotation center O, around which the droplet microfluidic chip 200 rotates in centrifugal operation. The plurality of droplet-producing units 100 are evenly distributed, surrounding the rotation center O. It should be noted that the term “surrounding” herein means that a closed loop may be formed or not formed. For example, a circular sector with a central angle larger than 180° or around 90° or the like can be formed by the surrounding of the droplet-producing units 100. It is to be understood that the degree of the central angle of the circular sector is not limited according to the needed loading amount.

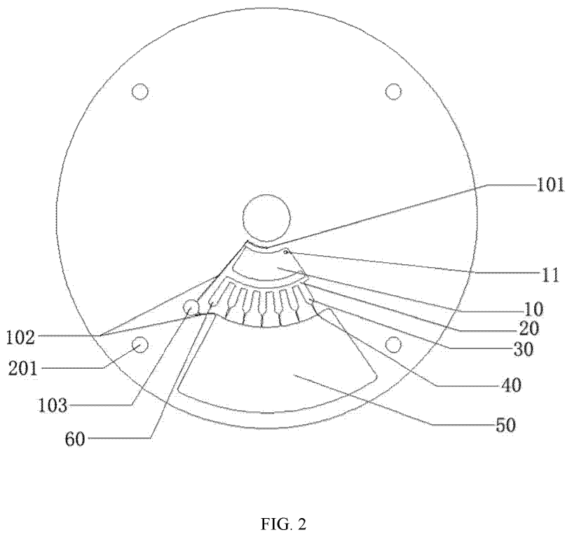

As shown in FIG. 2, each droplet-producing unit 100 includes a dispersion phase chamber 10, a quantitation chamber 30, a capillary nozzle 40, and a continuous phase chamber 50. The dispersion phase chamber 10 is proximal to the rotation center O and provided with a loading hole 11 through which a dispersion phase liquid is to be added. The quantitation chamber 30 is in communication with the dispersion phase chamber 10 and is further away from the rotation center O than the dispersion phase chamber 10. One end of the capillary nozzle 40 is in communication with the quantitation chamber 30 and extended from the joining position in a direction away from the rotation center O. The capillary nozzle 40 is further away from the rotation center O than the quantitation chamber 30. The continuous phase chamber 50 is in communication with the other end of the capillary nozzle 40 away from the quantitation chamber 30, and the continuous phase chamber 50 is further away from the rotation center O than the capillary nozzle 40. The continuous phase chamber 50 is configured to pre-store a continuous phase liquid.

In use of the above-described droplet microfluidic chip 200, the dispersion phase liquid (e.g., various reagents in the biochemical detection) can be loaded into the dispersion phase chamber 10 through the loading hole 11. Then the droplet microfluidic chip 200 is centrifuged with a low centrifugal force so that the dispersion phase liquid is thrown into the quantitation chamber 30. Thereafter, the dispersion phase liquid is forced into the continuous phase chamber 50 through the capillary nozzle 40 by increasing the centrifugal force. The dispersion phase liquid is sprayed out from the capillary nozzle 40 due to the centrifugal force and enters the continuous phase chamber 50. The dispersion phase liquid is in contact with the continuous phase liquid in the continuous phase chamber 50, extruded and cut into microdroplets under the shear action of the continuous phase liquid. In the presence of the capillary nozzle 40, at relatively low centrifugal force (0 g to 100 g), the dispersion phase liquid is unable to be thrown out into the continuous phase chamber 50 due to the surface tension of the liquid, thereby ensuring the uniformity and the stability of the droplets produced by the chip. The droplet microfluidic chip 200 can stably and rapidly produce droplets with a uniform size by utilizing the centrifugal force as driving force of the droplet production and by varying parameter configurations. In the centrifugal driving process, the liquid is divided equally, uniformly, and reliably, without the complicated operation to intercommunicate a plurality of micropumps and to accurately control the flow rate of the liquid in the conventional planner microfluidic chip. This is advantageous for decreasing the complexity and volume of the equipment. In addition, the final utilization efficiency of the liquid is significantly increased, and the loss and dead volume of the liquid in the flowing and transferring process is decreased. The centrifugal driving manner is simple without using complicated circuit control, optical module, and the like, which also reduces the size of the equipment and the control difficulty, decreases the manufacturing cost of the equipment, improves the reliability of the equipment, and reduces the subsequent maintaining difficulty of the equipment.

In the present embodiment, the droplet microfluidic chip 200 includes four droplet-producing units 100 evenly distributed surrounding the rotation center O and can produce microdroplets simultaneously for four samples of dispersion phase liquid. Each droplet-producing unit 100 can work separately with no mutual interference, thereby increasing the detection capability and throughput of the chip, achieving multi-target detection, integrating detection items, and reducing detection time. Of course, in other embodiments, the droplet microfluidic chip 200 can be in another shape such as rectangle, polygon, etc. The number of the droplet-producing units 100 can be one, two, three, five, seven, etc.

As shown in FIG. 2, in a specific embodiment, the droplet-producing unit 100 further includes a liquid-dispensing channel 20. A right side edge of the liquid-dispensing channel 20 is in communication with a right side edge of the dispersion phase chamber 10 through a microchannel. The liquid-dispensing channel 20 is extended around the rotation center O and further away from the rotation center O than the dispersion phase chamber 10. It is to be understood that a valve can be interposed between the liquid-dispensing channel 20 and the dispersion phase chamber 10. The valve can be, for example, a paraffin valve, a photosensitive wax valve, or a press valve, but is not limited thereto.

In the present embodiment, the quantitation chamber is a plurality of quantitation chambers 30. The plurality of quantitation chambers 30 are separately in communication with the liquid-dispensing channel 20, sequentially arranged at an outer side of the liquid-dispensing channel 20, and extended in a radial direction of the droplet microfluidic chip 200. In the present embodiment, the liquid-dispensing channel 20 as a whole is in a shape of a circular arc, whose circular center is at the rotation center O, so as to facilitate dispensing the dispersion phase liquid into respective quantitation chambers 30 through the liquid-dispensing channel 20. In the present embodiment, the volumes of the plurality of the quantitation chambers 30 are equal, so that the volumes of the dispersion phase liquid in the quantitation chambers 30 are equal, resulting in better stability and consistency in droplet formation.

The capillary nozzle 40 is a plurality of capillary nozzles 40. Each capillary nozzle 40 is in communication with a terminal end of one quantitation chamber 30. The number of the capillary nozzles 40 depends on the number of the quantitation chambers 30. The number of the droplets produced per unit of rotation speed depends on the number of the capillary nozzles 40. As such, the more the quantitation chambers 30, the more the capillary nozzles 40, the more the droplets produced under the action of the same centrifugal driving force.

In a specific embodiment, a cross-section of the capillary nozzle 40 is circular, oval, or rectangular with an equivalent diameter of 4 μm to 50 μm. The size of the droplets produced by the chip depends on the value of the centrifugal driving force and the size of the capillary nozzle 40. Generally, the larger centrifugal force and the smaller size of the capillary nozzle 40 will result in microdroplets with a smaller diameter. In the case of non-circular cross-section, the shear stress is non-uniformly distributed at the surrounding wall surface, and only the average value thereof along the perimeter can be calculated.

Generally, a ratio of four times the non-circular cross-section area to the wetted perimeter is approximately equivalent to the diameter of the circular cross-section. That is, 4A (non-circular cross-section area)/P (wetted perimeter)≈D (circular cross-section diameter). For example, the wetted perimeter of the rectangular cross-section is the perimeter of rectangle of the cross-section, so the equivalent diameter=4ab/2(a+b)=2ab/(a+b), wherein a is the length of the cross-section and b is the width of the cross-section.

An inner side of the continuous phase chamber 50 is in communication with the plurality of capillary nozzles 40. In a specific embodiment, the height of the continuous phase chamber 50 in a direction of a rotation axis of the droplet microfluidic chip 200 is smaller than two times the diameter of one droplet. In this way, the droplets are arranged in a single layer and not overlapped or staggered due to the limitation of the height of the continuous phase chamber 50, so that the optical signals of all individual droplets can be directly acquired in the detection process, without additional single droplet screening detection procedure as conventionally required after the liquid droplet production (the droplets are stacked and accumulated), thereby reducing the complexity of the supporting equipment. In the present embodiment, the height of the continuous phase chamber 50 is 80 μm to 150 μm. The height of the continuous phase chamber 50 can be adjusted according to the required diameter of the droplets (generally, 50 μm to 120 μm). For example, the height of the continuous phase chamber 50 can be slightly higher than the diameter of the single droplet (by 20 μm to 30 μm), so that the droplets can be well spread into one layer without being stacked in the height direction. Thus, the problem that the subsequent detection of the chip is difficult due to factors such as droplet agglomeration, overlapping, and staggering is solved, facilitating the subsequent optical detection.

In a specific embodiment, the droplet-producing unit 100 further includes a waste liquid chamber 60. The waste liquid chamber 60 is in communication with a terminal end of the liquid-dispensing channel 20 and is extended from the joining position in a direction away from the rotation center O. In this way, after the centrifugation, the plurality of quantitation chambers 30 are sequentially filled with the dispersion phase liquid from the openings of the liquid-dispensing channel 20, and the excessed dispersion phase liquid is flown into the waste liquid chamber 60.

In a specific embodiment, the droplet-producing unit 100 further includes a ventilating hole 101 and a ventilating conduit 102. The ventilating hole 101 is closer to the rotation center O than the dispersion phase chamber 10. The ventilating conduit 102 is extended at a side of the dispersion phase chamber 10 and the liquid-dispensing channel 20. The dispersion phase chamber 10 and the continuous phase chamber 50 are each in communication with the ventilating hole 101 through the ventilating conduit 102.

In a specific embodiment, the droplet-producing unit 100 further includes a filter 103 made of an air-permeable and liquid-tight material. The filter 103 is located at a side of the continuous phase chamber 50. The ventilating conduit 102 includes a first section communicating the ventilating hole 101 with the dispersion phase chamber 10, a second section communicating the dispersion phase chamber 10 with the filter 103, and a third section communicating the filter 103 and the continuous phase chamber 50. In this way, the continuous phase chamber 50 is in communication with the ventilating hole 101 through the filter 103. The filter 103 can ensure that the biological liquid added into the chip 200 is unable to be leaked out from the chip to the outside environment, thereby avoiding the biological pollution. The filter 103 allows ventilation, so that the ventilating hole 101, the ventilating conduit 102, and the filter 103 can play a role in balancing air pressures inside and outside the chip, and the smooth flow and transfer of the liquid inside the chip 20 can be ensured in the centrifugal process.

In a specific embodiment, the droplet microfluidic chip 200 further includes a locating hole 201. The locating hole 201 facilitates identification of the location of the droplet microfluidic chip 200 by supporting detection equipment and thus facilitates acquisition of corresponding results of the detection.

Optionally, the processing methods of the droplet microfluidic chip 200 include CNC, laser engraving, soft lithography, 3D printing, hot stamping, injection molding, and other methods, but are not limited thereto.

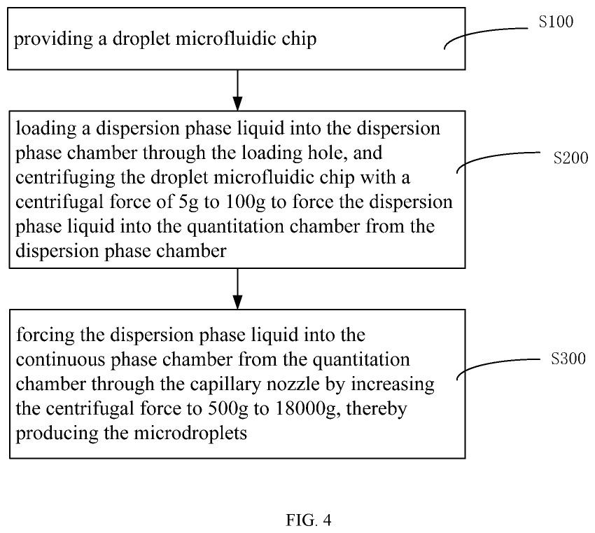

In a specific embodiment, as shown in FIG. 4, the droplet microfluidic chip 200 incudes a bottom plate 210, two double-faced adhesive layers 220, a middle plate 230, and a top plate 240. The above-described dispersion phase chamber 10, liquid-dispensing channel 20, quantitation chamber 30, capillary nozzle 40, continuous phase chamber 50, and the like are all defined in the middle plate 230. The loading hole 11, the ventilating hole 101, and the like are defined in the top plate 240. The two double-faced adhesive layers 220 are used to join the bottom plate 210, the middle plate 230, and the top plate 240. The material of the bottom plate 210, the middle plate 230, and the top plate 240 can be glass, silicon wafer, quartz, or polymeric material. The polymeric material includes one or more of polydimethylsiloxane (PDMS), polyurethane, epoxy resin, polymethyl methacrylate (PMMA), polycarbonate (PC), cyclic olefin copolymer (COC), polystyrene (PS), polyethylene (PE), polypropylene (PP), or fluorinated plastic. The double-faced adhesive layer 20 can be a double-faced adhesive tap with polyethylene terephthalate, polyurethane, ethylene-vinyl acetate, polyethylene, and/or polyvinyl chloride as a substrate and coated with acrylic (such as acrylate, cyanoacrylate) adhesive, organosilicon adhesive, and/or polyurethane adhesive.

Optionally, to satisfy a detection process of the equipment, at least one of the bottom plate 210 and the top plate 240 is made of a highly transparent material with a light transmittance larger than 90% at a wavelength in the range of 200 nm to 1100 nm. In order to decrease the background interference in the optical detection or as required by certain possible chip packaging process such as laser welding packaging process, one or all of the bottom plate 210, the middle plate 230, or the top plate 240 is made of an absolute black and non-transparent material. The absolute black and non-transparent material has a light transmittance larger than or equal to 98% at the wavelength in a range of 200 nm to 1100 nm. Both double-faced adhesive layers can be made of a transparent material.

As shown in FIG. 4, an embodiment of the present disclosure provides a method for producing microdroplets, including the following steps:

step S100, providing the above-described droplet microfluidic chip 200;

step S200, loading the dispersion phase liquid into the dispersion phase chamber 10 through the loading hole 11, and centrifuging the droplet microfluidic chip 200 with a centrifugal force of 5 g to 100 g to force the dispersion phase liquid into the quantitation chamber 30 from the dispersion phase chamber 10;

step S300, forcing the dispersion phase liquid into the continuous phase chamber 50 from the quantitation chamber 30 through the capillary nozzle 40 by increasing the centrifugal force to 500 g to 18000 g, thereby producing the microdroplets.

In the above-described method for producing microdroplets, the droplets with a uniform size can be produced stably and rapidly by utilizing the centrifugal force as driving force of droplet production and by varying parameter configurations. At relatively low centrifugal force (0 g to 100 g), the dispersion phase liquid is unable to be thrown out into the continuous phase chamber 50 due to the surface tension of the liquid, thereby ensuring the uniformity and the stability of the droplets produced by the chip. In the centrifugal driving process, the liquid is divided equally, uniformly, and reliably, without the complicated operation to intercommunicate a plurality of micropumps and to accurately control the flow rate of the liquid in the conventional planner microfluidic chip. This is advantageous for decreasing the complexity and volume of the equipment. In addition, the final utilization efficiency of the liquid is significantly increased. The loss and dead volume of the liquid in the flowing and transferring process is decreased. The centrifugal driving manner is simple without using complicated circuit control, optical module, and the like, which also reduces the size of the equipment and the control difficulty, decreases the manufacturing cost of the equipment, improves the reliability of the equipment, and the subsequent maintaining difficulty of the equipment.

It is to be understood that the amount of the liquid sprayed out from the capillary nozzle 40 can be controlled by varying the rotation speed. The higher the rotation speed, the less the amount of the liquid sprayed out. The increase in centrifugal radius of the nozzle (a distance from the joining position between the capillary nozzle 40 and the continuous phase chamber 50 to the rotation center) can decrease the required rotation speed while keeping the centrifugal force and the size of the produced droplets from being changed. Referring to Table 1 (taken the capillary nozzle 40 with the equivalent cross-section diameter φ=6 μm as an example).

| Centrifugal | Centrifugal | Centrifugal | Droplet |
|---|---|---|---|
| radius | rotation speed | force | diameter |
| (cm) | (rpm) | (g) | (μm) |
| 1.4 | 8050 | 1000 | 164.3 ± 18.3 |
| 1.4 | 13900 | 3000 | 92.4 ± 12.9 |
| 1.4 | 17990 | 5000 | 74.8 ± 7.8 |
| 1.4 | 21230 | 7000 | 67.9 ± 1.3 |
| 1.8 | 7100 | 1000 | 164.3 ± 18.3 |
| 1.8 | 12260 | 3000 | 92.4 ± 12.9 |
| 1.8 | 15830 | 5000 | 74.8 ± 7.8 |
| 1.8 | 18720 | 7000 | 67.9 ± 1.3 |

The values of the cross-section diameter of the nozzle and the centrifugal force will finally affect the size and the dimension uniformity of the droplets produced. The value of the centrifugal force in turn depends on the centrifugal radius and the centrifugal rotation speed. In practice, the centrifugal radius of the nozzle can be appropriately increased. As the centrifugal radius is increased by n times, the centrifugal force is increased by n times. Without changing the size of the chip, the increase of the centrifugal radius of the nozzle will decrease the axial width of the continuous phase chamber 50. However, as the size of each droplet produced is also decreased, the continuous phase chamber 50 with the decreasedaxial width can still contain the same number of droplets. As the axial width of the continuous phase chamber 50 is decreased, the photographing scope and region in the subsequent optical detection is also reduced, thereby shorting the detection time. Alternatively, without changing the centrifugal radius of the nozzle, the centrifugal rotation speed can be changed. As the centrifugal rotation speed is increased by n times, the centrifugal force is increased by n² times. Nonetheless, increasing the centrifugal rotation speed is not so friendly to the research investment of the supporting equipment. In comparison, the change in the centrifugal radius of the nozzle is easier to achieve and lower in cost.

In a specific embodiment, the density of the continuous phase liquid is smaller than the density of the dispersion phase liquid, and the density difference is smaller than 0.35 g/cm³. The viscosity of the continuous phase liquid is 5 cSt to 20 cSt. The density of the continuous phase (oil phase) is slightly smaller than that of the dispersion phase (liquid phase), so that the droplets can be always deposited onto the bottom surface of the chip in the centrifugal process and the subsequent detection process, thus facilitating the spreading of the droplets and allowing the droplets to be at the same horizontal plane in detection. The difference between densities of the continuous phase (oil phase) and the dispersion phase (liquid phase) should be as small as possible, so that breaking of the droplets and fusion between the droplets in the centrifugal process can be reduced. The continuous phase (oil phase) liquid with a low viscosity such as 10 cSt is more suitable, which is advantageous for ensuing that the dispersion phase (liquid phase) liquid can be smoothly introduced into the continuous phase (oil phase) from the capillary nozzle 40 in the centrifugation, thereby ensuring the successful production of the droplets.

In a specific embodiment, the continuous phase liquid includes a surfactant and a long chain alkyl ester. The continuous phase (oil phase) liquid shall be biocompatible with the dispersion phase (liquid phase) reagent, has no reaction with the dispersion phase (liquid phase) reagent or can inhibit the reaction of the dispersion phase (liquid phase) reagent. Optionally, a surfactant is added into the continuous phase liquid or the dispersion phase liquid to improve the stability of the droplets. Preferably, the continuous phase liquid includes a siloxane chain nonionic surfactant (2% to 20% by volume) having a long chain alkyl and includes a long chain alkyl ester (80% to 98% by volume). Optionally, the long chain alkyl ester includes one or more of methyl palmitate, ethyl palmitate, isopropyl palmitate, propyl laurate, butyl laurate, methyl laurate, ethyl laurate, isoamyl laurate, methyl oleate, ethyl oleate, glyceryl oleate, methyl stearate, ethyl stearate, vinyl stearate, butyl stearate, or glyceryl stearate.

In an embodiment, the amount of the dispersion phase liquid in each loading is 5 μL to 100 μL. The volume of the continuous phase liquid in the continuous phase chamber 50 is 300 μL to 1500 μL.

The technical features of the above-described embodiments can be combined arbitrarily. To simplify the description, not all possible combinations of the technical features in the above embodiments are described. However, all of the combinations of these technical features should be considered as being fallen within the scope of the present disclosure, as long as such combinations do not contradict with each other.

The foregoing embodiments merely illustrate some embodiments of the present disclosure, and descriptions thereof are relatively specific and detailed. However, it should not be understood as a limitation to the patent scope of the present disclosure. It should be noted that, a person of ordinary skill in the art may further make some variations and improvements without departing from the concept of the present disclosure, and the variations and improvements falls in the protection scope of the present disclosure. Therefore, the protection scope of the present disclosure shall be subject to the appended claims.

1. A droplet microfluidic chip, comprising at least one droplet-producing unit and having a rotation center, wherein the droplet-producing unit comprises:
a dispersion phase chamber being proximal to the rotation center and provided with a loading hole configured to introduce a dispersion phase liquid;
a quantitation chamber being in communication with the dispersion phase chamber and further away from the rotation center than the dispersion phase chamber;
a capillary nozzle, one end of the capillary nozzle being in communication with the quantitation chamber and extended in a direction away from the rotation center, and the capillary nozzle being further away from the rotation center than the quantitation chamber; and
a continuous phase chamber configured to pre-store a continuous phase liquid, the continuous phase chamber being in communication with another end of the capillary nozzle away from the quantitation chamber, and the continuous phase chamber being further away from the rotation center than the capillary nozzle.

2. The droplet microfluidic chip of claim 1, wherein the droplet-producing unit further comprises a liquid-dispensing channel, the liquid-dispensing channel is in communication with the dispersion phase chamber and extended around the rotation center, and the liquid-dispensing channel is further away from the rotation center than the dispersion phase chamber.

3. The droplet microfluidic chip of claim 2, wherein the quantitation chamber is a plurality of quantitation chambers, the plurality of quantitation chambers are separately in communication with the liquid-dispensing channel, sequentially arranged at an outer side of the liquid-dispensing channel, and extended in a radial direction.

4. The droplet microfluidic chip of claim 3, wherein the capillary nozzle is a plurality of capillary nozzles, and the plurality of capillary nozzles are corresponding to the plurality of quantitation chambers in a one-to-one manner.

5. The droplet microfluidic chip of claim 2, wherein the liquid-dispensing channel is in a shape of a circular arc whose circular center is at the rotation center.

6. The droplet microfluidic chip of claim 2, wherein the droplet-producing unit further comprises a waste liquid chamber, the waste liquid chamber is in communication with a terminal end of the liquid-dispensing channel and extended in a direction away from the rotation center.

7. The droplet microfluidic chip of claim 2, wherein the liquid-dispensing channel is in communication with the dispersion phase chamber through a microchannel.

8. The droplet microfluidic chip of claim 1, wherein a cross-section of the capillary nozzle is circular, oval, or square.

9. The droplet microfluidic chip of claim 1, wherein an equivalent diameter of the capillary nozzle is about 4 μm to about 50 μm.

10. The droplet microfluidic chip of claim 1, wherein a height of the continuous phase chamber is about 80 μm to about 150 μm.

11. The droplet microfluidic chip of claim 1, wherein the droplet-producing unit further comprises a ventilating hole and a ventilating conduit, the ventilating hole is closer to the rotation center than the dispersion phase chamber, and the dispersion phase chamber and the continuous phase chamber are each in communication with the ventilating hole through the ventilating conduit.

12. The droplet microfluidic chip of claim 11, wherein the droplet-producing unit further comprises a filter, the filter is made of an air-permeable and liquid-tight material, and the continuous phase chamber and the ventilating hole each are in communication with the filter through the ventilating conduit.

13. The droplet microfluidic chip of claim 1, further comprising a bottom plate, a middle plate, and a top plate which are sequentially stacked, wherein the dispersion phase chamber, the quantitation chamber, the capillary nozzle, and the continuous phase chamber are defined in the middle plate.

14. The droplet microfluidic chip of claim 13, further comprising double-faced adhesive layers respectively disposed between the bottom plate and the middle plate and between the middle plate and the top plate.

15. The droplet microfluidic chip of claim 1, wherein the droplet-producing unit is a plurality of droplet-producing units evenly distributed, surrounding the rotation center.

16. A method for producing microdroplets, comprising:
providing the droplet microfluidic chip of claim 1;
loading a dispersion phase liquid into the dispersion phase chamber through the loading hole, and centrifuging the droplet microfluidic chip with a centrifugal force of about 5 g to about 100 g to force the dispersion phase liquid into the quantitation chamber from the dispersion phase chamber;
forcing the dispersion phase liquid into the continuous phase chamber from the quantitation chamber through the capillary nozzle by increasing the centrifugal force to about 500 g to about 18000 g, thereby producing the microdroplets.

17. The method of claim 16, wherein a density of the continuous phase liquid is smaller than a density of the dispersion phase liquid, and a density difference between the continuous phase liquid and the dispersion phase liquid is smaller than 0.35 g/cm³.

18. The method of claim 16, wherein a viscosity of the continuous phase liquid is about 5 cSt to about 20 cSt.
